(19) United States
(12) Patent Application Publication
(10) Pub. No.: US 2012/0211031 A1
(43) Pub. Date: Aug. 23, 2012

(54) Discrete Or Single Dose Detergent Formulation

(75) Inventors: Matthias Loeffler, Idstein (DE); Ernesto Iwao Horikoshi, Riehen (CH); Gustavo Kume, Sao Paulo (BR); Ana Regina Coimbra, Sao Paulo (BR)

(73) Assignees: CLARIANT S.A., BRAZIL, Sao Paulo (BR); CLARIANT FINANCE (BVI) LIMITED, Tortola (VG)

(21) Appl. No.: 13/501,669

(22) PCT Filed: Oct. 7, 2010
(86) PCT No.: PCT/EP2010/006126

§ 371 Date: May 15, 2012

(30) Foreign Application Priority Data
Oct. 13, 2009 (EP) 09012898.4

(51) Int. Cl. A47L 15/42; C08F 226/08; C08F 228/02; C11D 17/00

(52) U.S. Cl. 134/25.2; 510/224; 510/219; 526/263; 526/287

(57) ABSTRACT

A discrete or single dose detergent formulation is described. The formulation comprises special copolymers A. These copolymers A comprise structural units originating from
a1) one or more special monomers comprising a cyclic amide structure or
a2) one or more special alkoxylated monomers and
b) one or more special monomers comprising an amido group and a sulfonic acid group in protonated or in salt form and may be crosslinked or non-crosslinked.

The discrete or single dose detergent formulations are particularly suited for treating table ware or glasses in automatic dishwashing machines.

The present invention relates to discrete or single dose detergent formulations comprising special copolymers A, to a process for the preparation of these discrete or single dose detergent formulations and to a method for treating table ware or glasses in an automatic dishwashing machine using named discrete or single dose detergent formulations.

Polymers based on acryloyldimethyltaurate have been shown to be useful consistency-imparting agents in liquid formulations. EP 140 583 describes liquid washing and cleaning compositions comprising acryloyldimethyltaurate polymers. EP 1 477 553 discloses acidic formulations comprising such polymers. However, even relatively high concentrated, commercially available liquid products normally have a high amount of water which leads to high transportation costs etc. In addition, the user tends to overdose such concentrates in practice which in turn has a negative influence on the environment.

Furthermore, if products are formulated as solids such as powders or granules, the end consumer has to use dosing aids for measuring the quantity of solid to be used for the intended application with the attendant risk of skin contact with the concentrated product.

Accordingly, both liquid and solid formulations such as detergents have the disadvantage that exact, ecologically safe and repeatable dosing is difficult for the end consumer to achieve. This is a disadvantage from the perspective of environmentally friendly application.

Detergent compositions in discrete or single dose form such as in tablet form are known in the art. It is understood that detergent compositions in such a form have several advantages in comparison to detergent compositions in the form of powders or granules, e. g. easier dosing, handling, transportation and storage.

Detergent tablets are most commonly prepared by pre-mixing components of a detergent composition and forming the pre-mixed detergent components into a tablet using any suitable equipment, preferably a tablet press. Tablets are typically formed by compression of the components of the detergent composition so that the tablets produced are sufficiently robust to be able to withstand handling and transportation without sustaining damage. In addition to being robust, tablets must also dissolve sufficiently fast so that the detergent components are released into the wash water as soon as possible at the beginning of the wash cycle.

However, a dichotomy exists in that as compression force is increased, the rate of dissolution of the tablets becomes slower.

Therefore, the object to be solved by the present invention was to provide a storable dosage form for detergents, preferably for auto dishwashing applications, which may be present in a highly concentrated form and may be used in a simple and safe manner by the consumer without any of the disadvantages mentioned above.

Surprisingly, it has now been found that this object is solved by discrete or single dose detergent formulations comprising one or more copolymers A which in turn comprise

a1) of from 1 to 50% by weight of one or more of the repeating structural units of the formula (1)

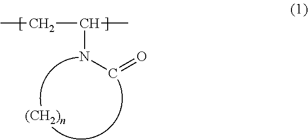

where

n is an integer of from 2 to 9

or

a2) of from 1 to 50% by weight of one or more of the repeating structural units of the formula (2)

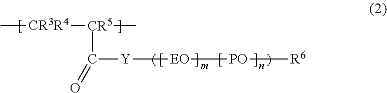

where
R³, R⁴ and R⁵ are, independently of one another, hydrogen or methyl,
R⁶ is hydrogen or an n-aliphatic, isoaliphatic, olefinic, cycloaliphatic, arylaliphatic or aromatic (C₁-C₃₀)-hydrocarbon radical,
Y is O or NH and
m and n are the stoichiometric coefficients relating to the ethylene oxide units (EO) and propylene oxide units (PO) and are, independently of one another, of from 0 to 50 where the sum of m and n must on average be 1 and the distribution of the EO and PO units over the -[EO]ₘ—[PO]ₙ— chain may be random, block-like, alternating or gradient-like,

and

b) of from 49.99 to 98.99% by weight of one or more of the repeating structural units of the formula (3)

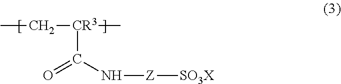

where
R³ is hydrogen or methyl,
Z is (C₁-C₈)-alkylene and
X is selected from the group consisting of H⁺, Li⁺, Na⁺, K⁺, Mg⁺⁺/2, Ca⁺⁺/2, Al⁺⁺⁺/3, NH₄⁺, monoalkylammonium, dialkylammonium, trialkylammonium and tetraalkylammonium, where the alkyl groups in these ammonium ions comprise, independently of one another, of from 1 to 30 carbon atoms.

Therefore, the invention provides discrete or single dose detergent formulations comprising one or more copolymers A which comprise

a1) of from 1 to 50% by weight of one or more of the repeating structural units of the formula (1)

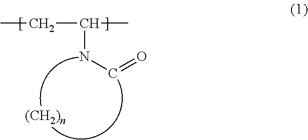

where
n is an integer of from 2 to 9

or

a2) of from 1 to 50% by weight of one or more of the repeating structural units of the formula (2)

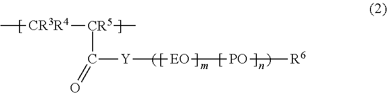

where
R³, R⁴ and R⁵ are, independently of one another, hydrogen or methyl,
R⁶ is hydrogen or an n-aliphatic, isoaliphatic, olefinic, cycloaliphatic, arylaliphatic or aromatic (C₁-C₃₀)-hydrocarbon radical,
Y is O or NH and
m and n are the stoichiometric coefficients relating to the ethylene oxide units (EO) and propylene oxide units (PO) and are, independently of one another, of from 0 to 50 where the sum of m and n must on average be 1 and the distribution of the EO and PO units over the -[EO]ₘ—[PO]ₙ— chain may be random, block-like, alternating or gradient-like,

and

b) of from 49.99 to 98.99% by weight of one or more of the repeating structural units of the formula (3)

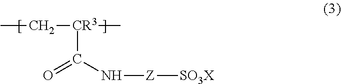

where
R³ is hydrogen or methyl,
Z is (C₁-C₈)-alkylene and
X is selected from the group consisting of H⁺, Li⁺, Na⁺, K⁺, Mg⁺⁺/2, Ca⁺⁺/2, Al⁺⁺⁺/3, NH₄⁺, monoalkylammonium, dialkylammonium, trialkylammonium and tetraalkylammonium, where the alkyl groups in these ammonium ions comprise, independently of one another, of from 1 to 30 carbon atoms.

The inventive discrete or single dose detergent formulations are present in the form of one single object, preferably in the form of a tablet. In contrast to powders or granules the inventive discrete or single dose detergent formulations have a higher weight compared to the single particulate of the powder or granule. Preferably, the weight of the inventive discrete or single dose detergent formulations, i. e. of the single objects such as a single tablet, is 1.0 g or more.

The inventive discrete or single dose detergent formulations possess improved stability, robustness and product integrity together with excellent dissolution characteristics. They furthermore show advantageous rinse effects when applied in automatic dishwashing machines and reduce the adhesion forces between the surface of table ware or glasses and adhered food.

Copolymers A and their preparation are e.g. described in EP 1 116 733 and EP 1 069 142.

The copolymers A comprise structural units of formulae (1) and (3) or of formulae (2) and (3) and optionally further structural units.

In a preferred embodiment of the invention the copolymers A comprise structural units of the formulae (1) and (3) and are crosslinked.

In a further preferred embodiment of the invention the copolymers A comprise structural units of the formulae (2) and (3) and are non-crosslinked.

In a further preferred embodiment of the invention the copolymers A comprise structural units of the formulae (2) and (3) and are crosslinked.

In a further preferred embodiment of the invention the copolymers A comprise of from 2 to 30% by weight, preferably of from 3 to 20% by weight and particularly preferably of from 3 to 15% by weight, of one or more structural units of formula (1) or (2), preferably of one or more structural units of the formula (1), and of from 69.5 to 97.5% by weight, preferably of from 79.5 to 96.5% by weight and particularly preferably of from 84.5 to 96.5% by weight, of one or more structural units of the formula (3).

In a further preferred embodiment of the invention the copolymers A comprise of from 1.1 to 50% by weight, preferably of from 2 to 30% by weight, particularly preferably of from 3 to 20%. by weight and especially preferably of from 3 to 15% by weight, of one or more structural units of formula (1) or (2), preferably of one or more structural units of the formula (1), and of from 50 to 98.9% by weight, preferably of from 70 to 98% by weight, particularly preferably of from 80 to 97% by weight and especially preferably of from 85 to 97% by weight, of one or more structural units of the formula (3).

The copolymers A may either be non-crosslinked or crosslinked.

In a preferred embodiment of the invention the copolymers A are crosslinked. In this case they comprise preferably of from 0.01 to 8% by weight, particularly preferably of from 0.2 to 3% by weight and especially preferably of from 0.5 to 2% by weight of one or more crosslinking structures originating from one or more monomers having at least two olefinic double bonds.

The one or more monomers having at least two olefinic double bonds are preferably selected from the group consisting of allyl acrylate, allyl methacrylate, tetraethylene glycol diacrylate, trimethylolpropane triacrylate, trimethylolpropane trimethacrylate, dipropylene glycol diallyl ether, polyglycol diallyl ether, hydroquinone diallyl ether, trimethylolpropane diallyl ether, tetraallyloxyethane, triethylene glycol divinyl ether or other allyl or vinyl ethers of polyfunctional alcohols, triallylamine, methylenebisacrylamide and divinylbenzene.

Particular preference is given to allyl acrylate, allyl methacrylate, trimethylolpropane triacrylate and/or trimethylolpropane trimethacrylate.

In a further preferred embodiment of the invention the copolymers A possess a molecular weight M_{w} of from 10³ to 10⁹ g/mol. Particularly preferably the copolymers A possess a molecular weight M_{w} of from 10⁴ to 10⁷ g/mol and especially preferably the copolymers A possess a molecular weight M_{w} of from 5·10⁴ to 5·10⁶ g/mol. M_{w} is for the purposes of this invention generally to be determined by GPC (gel permeation chromatography) against polystyrenesulfonic acid.

In a further preferred embodiment of the invention the one or more structural units of the formula (1) originate from substances selected from the group consisting of N-vinylpyrrolidone (NVP) and N-vinylcaprolactam.

In a further preferred embodiment of the invention in the one or more structural units of the formula (2) R³, R⁴ and R⁵ are, independently of one another, hydrogen or methyl, R⁶ is an n-aliphatic, isoaliphatic or olefinic (C₈-C₂₂)-hydrocarbon radical, Y is O or NH, preferably Y is O, n is 0 and m is 1 to 30.

In a further preferred embodiment of the invention in the one or more structural units of the formula (3) R³ is hydrogen or methyl, Z is C₄-alkylene, preferably Z is —C(CH₃)₂—CH₂—, and X is selected from the group consisting of H⁺, Na⁺and NH₄⁺. Particularly preferably the one or more copolymers A comprise structural units of the formula (3) wherein R³ is hydrogen, Z is —C(CH₃)₂—CH₂— and X is Na⁺.

In the one or more repeating structural units of the formula (3) X may be H⁺. If the copolymers A comprise one or more repeating structural units of the formula (3) wherein X is H⁺ the neutralization degree of the one or more repeating structural units of the formula (3) preferably is 90% or more. This means that X has a meaning different from H⁺ in 90 mol-% or more of the one or more repeating structural units of the formula (3). If the copolymers A comprise one or more repeating structural units of the formula (3) wherein X is H⁺ the neutralization degree of the one or more repeating structural units of the formula (3) particularly preferably is 95% or more and especially preferably is 98% or more.

In another preferred embodiment of the invention all of the counter ions X in the one or more repeating structural units of the formula (3) have a meaning different from H⁺, i.e. in this preferred embodiment of the invention the neutralization degree of the one or more repeating structural units of the formula (3) is 100%.

In a further preferred embodiment of the invention the copolymers A consist of the one or more structural units of formula (1) or (2), the one or more structural units of the formula (3) and optionally the one or more crosslinking structures originating from one or more monomers having at least two olefinic double bonds.

The inventive discrete or single dose detergent formulations preferably comprise the one or more copolymers A in an amount of from 0.1 to 10% by weight, particularly preferably in an amount of from 0.5 to 7% by weight and especially preferably in an amount of from 2 to 5% by weight, based on the total weight of the inventive discrete or single dose detergent formulation.

In a preferred embodiment of the invention the discrete or single dose detergent formulations are present in the form of a multiphase tablet.

In a further preferred embodiment of the invention the discrete or single dose detergent formulations are coated or encapsulated, preferably in water-soluble polymer foils such as polyvinyl alcohol foils.

In a further preferred embodiment of the invention the discrete or single dose detergent formulations are present in the form of compressed particulate solids.

The inventive discrete or single dose detergent formulations may comprise surfactants, builders, enzymes, bleaching agents, bleach activators, bleach catalysts, alkali carriers, organic polymers, heavy metal sequestrants, corrosion inhibitors, pH regulators, disrupting agents and/or hydrotropes. Such components are well known to those skilled in the art.

Surfactants suitable herein include anionic, nonionic and/or amphoteric surfactants, more especially low-foaming nonionic surfactants. Such compounds are preferably C₁₂₋₁₈ alkyl polyethylene glycol polypropylene glycol ethers containing up to 25 moles of ethylene oxide units and up to 8 moles of propylene oxide units in the molecule. However, other known low-foaming nonionic surfactants may also be used, including for example C₁₂₋₁₈ alkyl polyethylene glycol polybutylene glycol ethers containing up to 8 moles of ethylene oxide units and up to 8 moles of butylene oxide units in the molecule, end-capped alkyl polyalkylene glycol mixed ethers and the foaming, but ecologically attractive C₈₋₁₄ alkyl polyglucosides with a degree of polymerization of about 1 to 4 and/or C₁₂₋₁₄ alkyl polyethylene glycols containing 3 to 8 ethylene oxide units in the molecule. Surfactants from the glucamide family, for example alkyl-N-methyl glucamides in which the alkyl moiety preferably emanates from a C₆₋₁₄ fatty alcohol, are also suitable. The described surfactants may also be advantageously used in the form of mixtures, for example in the form of a mixture of alkyl polyglycoside with fatty alcohol ethoxylates or a mixture of glucamide with alkyl polyglycosides.

Other suitable surfactants are alkyl sulfates, alkyl ether sulfates, alkyl benzene sulfonates, alkyl glyceryl sulfonates, alkyl and alkenyl sulphonates, alkyl ethoxy carboxylates, N-acyl sarcosinates, N-acyl taurates and alkyl succinates and sulfosuccinates, wherein the alkyl, alkenyl or acyl moiety is C₅₋₂₀, preferably C₁₀₋₁₈, and is furthermore linear or branched.

Surfactants are preferably present at a level of from 0.2 to 30% by weight, particularly preferably of from 0.5 to 10% by weight and especially preferably of from 1 to 5% by weight, based on the total weight of the inventive discrete or single dose detergent formulation.

Builders suitable for use herein include water-soluble builders such as citrates, carbonates and polyphosphates and partially water-soluble or insoluble builders such as crystalline layered silicates and aluminosilicates inclusive of Zeolites A, B, P, X, HS and MAP.

The builder is preferably present at a level of from 1 to 80% by weight, particularly preferably of from 10 to 70% by weight and especially preferably of from 20 to 60% by weight, based on the total weight of the inventive discrete or single dose detergent formulation.

Enzymes suitable herein include bacterial and fungal cellulases such as Carezyme and Celluzyme (Novo Nordisk A/S); peroxidases; lipases such as Amano-P (Amano Pharmaceutical Co.), M 1 Lipase® and Lipomax® (Gist-Brocades) and Lipolase® and Lipolase Ultra® (Novo); cutinases; proteases such as Esperase®, Alcalase®, Durazym® and Savinase® (Novo) and Maxatase®, Maxacal®, Properase® and Maxapem® (Gist-Brocades); and amylases such as Purafect Ox Am® (Genencor) and Termamyl®, Ban®, Fungamyl®, Duramyl®, and Natalase® (Novo); Subtilisin® and mixtures thereof.

Enzymes are preferably added herein as prills, granulates or cogranulates at levels preferably in the range of from 0.0001 to 2% by weight pure enzyme, based on the total weight of the inventive discrete or single dose detergent formulation.

The inventive discrete or single dose detergent formulations may comprise bleaching agents or bleaching compositions consisting of one or more bleaching agents and one or more bleach activators in levels preferably of from 0.1 to 30% by weight and particularly preferably of from 1 to 5% by weight, based on the total weight of the discrete or single dose detergent formulation.

If present, the amount of bleach activator preferably will be of from 0.1 to 60% by weight and particularly preferably of from 0.5 to 40% by weight, based on the total weight of the bleaching composition consisting of bleaching agent and bleach activator.

Suitable oxygen-based bleaching agents are alkali metal perborate monohydrate and tetrahydrate and/or alkali metal percarbonate and alkali metal persulfates, persilicates and percitrates, sodium being the preferred alkali metal. The use of sodium percarbonate has advantages, especially in dishwashing detergents, because it has a particularly favorable effect on the corrosion behavior of glasses. Accordingly, the oxygen-based bleaching agent is preferably an alkali metal percarbonate and particularly preferably sodium percarbonate. Known peroxycarboxylic acids, for example dodecane diperacid, or phthalimidopercarboxylic acids which may optionally be substituted at the aromatic radical may be present in addition to or, more particularly, as an alternative to the oxygen-based bleaching agent. Moreover, the addition of small quantities of known bleach stabilizers, for example phosphonates, borates and metaborates and metasilicates and also magnesium salts, such as magnesium sulfate, can be useful.

Mixtures of bleaching agents can also be used.

Peroxygen bleaching agents such as perborates, percarbonates, etc., are preferably combined with bleach activators, which lead to the in situ production in aqueous solution (i.e. during the washing process) of the peroxy acid corresponding to the bleach activator.

Known conventional bleach activators, i.e. compounds which form aliphatic peroxocarboxylic acids preferably containing 1 to 10 carbon atoms and particularly preferably containing 2 to 4 carbon atoms and/or optionally substituted perbenzoic acid under perhydrolysis conditions, may be used. Suitable conventional bleach activators are substances which carry O- and/or N-acyl groups with the number of carbon atoms mentioned and/or optionally substituted benzoyl groups. Preferred conventional bleach activators are polyacylated alkylenediamines, particularly preferably tetraacetyl ethylenediamine (TAED), acylated triazine derivatives, particularly preferably 1,5-diaacetyl-2,4-dioxohexahydro-1,3,5-triazine (DADHT), acylated glycolurils, particularly preferably tetraacetyl glycoluril (TAGU), N-acyl imides, pafticularly preferably N-nonanoyl succinimide (NOSI), carboxylic anhydrides, particularly preferably phthalic anhydride, acylated polyhydric alcohols, particularly preferably triacetin, ethylene glycol diacetate, 2,5-diacetoxy-2,5-dihydrofuran and the enol and also acetylated sorbitol and mannitol and the mixtures thereof (SORMAN), acylated sugar derivatives, particularly preferably pentaacetyl glucose (PAG), pentaacetyl fructose, tetraacetyl xylose and octaacetyl lactose and acetylated, optionally N-alkylated, glucamine and glucolactone, and/or the N-acylated lactams, for example N-benzoyl caprolactam.

Highly preferred bleach activators are nonanoyloxybenzene sulfonate (NOBS) and tetraacetyl ethylene diamine (TAED) and mixtures thereof.

In addition to or instead of the conventional bleach activators mentioned above, transition metal complexes may be present as so-called bleach catalysts. Suitable transition metal compounds are e.g. described in U.S. Pat. No. 6,015,784.

The inventive discrete or single dose detergent formulations may comprise bleach catalysts, preferably of from 0.01 to 0.1% by weight, based on the total weight of the inventive discrete or single dose detergent formulation.

The inventive discrete or single dose detergent formulation may comprise the usual alkali carriers, for example alkali metal silicates, alkali metal carbonates and/or alkali metal hydrogen carbonates. The alkali carriers normally used include carbonates, hydrogen carbonates and alkali metal silicates with a molar SiO₂:M₂O ratio (M=alkali metal atom) of 1:1 to 2.5:1. Alkali metal silicates may preferably be present in quantities of up to 40% by weight, based on the total weight of the inventive discrete or single dose detergent formulation.

The alkali carrier system preferably used in the inventive discrete or single dose detergent formulations is a mixture of carbonate and hydrogen carbonate, preferably sodium carbonate and hydrogen carbonate, which preferably is present in a quantity of up to 50% by weight and particularly preferably in a quantity of from 5 to 40% by weight, based on the total weight of the inventive discrete or single dose detergent formulation. The ratio of carbonate used to hydrogen carbonate used varies according to the pH value ultimately required.

Other suitable components herein include organic polymers having dispersant, antiredeposition, soil release or other detergency properties. These organic polymers preferably are used in levels of from 0.1 to 30% by weight, particularly preferably of from 0.5 to 15% by weight and especially preferably of from 1 to 10% by weight, based on the total weight of the inventive discrete or single dose detergent formulation.

Heavy metal sequestrants are suitable for use herein in levels preferably of from 0.005 to 20% by weight, particularly preferably of from 0.1 to 10% by weight, especially preferably of from 0.25 to 7.5% by weight and extraordinarily preferably of from 0.5 to 5% by weight, based on the total weight of the inventive discrete or single dose detergent formulation, for example diethylenetriamine penta (methylene phosphonate), ethylenediamine tetra (methylene phosphonate), hexamethylenediamine tetra (methylene phosphonate), ethylene diphosphonate, hydroxyethylene-1,1-diphosphonate, nitrilotriacetate, ethylenediaminotetraacetate, ethylenediamine-N,N′-disuccinate in their salt and free acid forms.

The inventive discrete or single dose detergent formulations may comprise a corrosion inhibitor such as organic silver coating agents in levels preferably of from 0.05 to 10% by weight and particularly preferably of from 0.1 to 5% by weight, based on the total weight of the inventive discrete or single dose detergent formulation (especially paraffins such as Winog 70 sold by Wintershall, Salzbergen, Germany), nitrogen containing corrosion inhibitor compounds (for example benzotriazole and benzimadazole) and Mn(II)compounds, preferably Mn(II)salts of organic ligands, in levels preferably of from 0.005 to 5% by weight, particularly preferably of from 0.01 to 1% by weight and especially preferably of from 0.02 to 0.4% by weight, based on the total weight of the inventive discrete or single dose detergent formulation.

In order to establish a desired pH value which is not automatically established by the mixture of the other components, the inventive discrete or single dose detergent formulations may comprise system-compatible and environmentally compatible acids, preferably citric acid, acetic acid, tartaric acid, malic acid, lactic acid, glycolic acid, succinic acid, glutaric acid and/or adipic acid and also mineral acids, preferably sulfuric acid, or alkali metal hydrogen sulfates or bases, preferably ammonium or alkali metal hydroxides. pH regulators such as these may be present in the inventive discrete or single dose detergent formulations in quantities of preferably not more than 10% by weight and particularly preferably in quantities of from 0.5 to 6% by weight, based on the total weight of the inventive discrete or single dose detergent formulation.

In order to achieve a quicker dissolution the inventive discrete or single dose detergent formulation may also comprise a disrupting agent, for example a mixture of compounds such as an acid and a base which effervesce when in the presence of water. A suitable disrupting agent is a mixture of an acid such as citric acid and a carbonate or bicarbonate such as sodium carbonate or sodium bicarbonate.

Hydrotropes are preferably selected from the group consisting of alkyl aryl sulfonates and aryl sulfonates and particularly preferably from cumene sulfonate, toluene sulfonate and xylene sulfonate and mixtures thereof.

The aqueous solution, preferably the 1% by weight aqueous solution, of the inventive discrete or single dose detergent formulations in the automatic. dishwashing machine preferably has a pH of from 7 to 13, particularly preferably a pH of from 8 to 12 and especially preferably a pH of from 9 to 11.

The inventive discrete or single dose detergent formulations are preferably prepared by mixing all the ingredients in a mixer and compressing or tabletting the resulting mixture in suitable devices such as conventional tablet presses, for example eccentric presses or rotary presses, preferably under pressures of from 200·10⁵ to 1500·10⁵ Pa. Fracture-resistant tablets which still dissolve sufficiently quickly under in-use conditions with flexural strengths of normally above 150 N are readily obtained in this way.

Therefore, the invention furthermore provides a process for the preparation of inventive discrete or single dose detergent formulations comprising the step of mixing all the ingredients in a mixer and compressing or tabletting the resulting mixture.

In a preferred embodiment of the invention the inventive discrete or single dose detergent formulations weigh of from 15 to 40 g and preferably of from 20 to 30 g, preferably for a diameter of from 35 to 40 mm, and preferably are present in the form of tablets.

The inventive discrete or single dose detergent formulations are particularly suited for treating table ware or glasses in automatic dishwashing machines.

Therefore, the invention furthermore provides a method for treating table ware or glasses in an automatic dishwashing machine comprising the step of dissolving an inventive discrete or single dose detergent formulation in water and contacting the surface of the table ware or glasses with this solution.

Preferably this inventive method comprises a cleaning and/or a rinsing step and particularly preferably a cleaning and a rinsing step.

Due to the adhesion forces between the surface of table ware or glasses and adhered food such as in the form of food incrustation the removal of the food in automatic dishwashing machines often is incomplete or requires excessive treatment such as longer washing times and/or higher temperatures etc. when detergent formulations of the prior art are used.

However, it was found that the inventive discrete or single dose detergent formulations when used in automatic dishwashing machines reduce the adhesion forces between the surface of table ware or glasses and food.

Therefore, the invention furthermore provides a method for reducing the adhesion forces between the surface of table ware or glasses and food by treating the surface of table ware or glasses with an inventive discrete or single dose detergent formulation in automatic dishwashing machines.

Food that adheres to table ware or glasses after they have been treated once with the inventive discrete or single dose detergent formulations in an automatic dishwashing machine adheres less strongly to the table ware or glasses and thus, can be removed easier in the following dishwashing cycles providing a next time cleaning effect.

Without being bound to this theory it is believed that the copolymers A applied in the inventive method create a protective layer on the surface of the table ware or glasses which reduces the adhesion forces between the surface of the table ware or glasses and the food.

The inventive discrete or single dose detergent formulations may be used both in domestic dishwashing machines and in institutional dishwashing machines. They are added either by hand or by means of suitable dispensers. The in-use concentrations in the wash liquor are preferably of from 1 to 8 g/l and particularly preferably of from 2 to 5 g/l.

A machine dishwashing program is generally augmented and terminated by a few intermediate rinses with clear water after the main wash cycle and a final rinse with a conventional rinse aid. Using the inventive discrete or single dose detergent formulations, completely clean and hygienically satisfactory dishes are obtained after drying.

The examples below serve to illustrate the invention in more detail without, however, limiting it thereto. All percentages given in these examples are percentages by weight (wt.-%).

In the following examples inventive discrete or single dose detergent formulations to be used in automatic dishwashing machines are disclosed.

### EXAMPLE A

| | |
|---|---|
| Pentasodium Triphosphate | 25.0% |
| Sodium Carbonate | 7.2% |
| TAED | 7.8% |
| Sodium Sulfate | 2.4% |
| Sodium Chloride | 0.1% |
| C₁₀₋₁₈ fatty alcohol with 16 EO and 1 PO | 14.1% |
| Sokalan ® CP5 | 12.4% |
| Polyvinylalcohol | 13.7% |
| Sucrose | 10.8% |
| Protease | 0.16% |
| Amylase | 0.14% |
| Copolymer A (select one of Copolymers 1-5) | 3.0% |
| Water | ad 100% |

### EXAMPLE B

| | |
|---|---|
| Pentasodium Triphosphate | 23.0% |
| Sodium Carbonate | 12.6% |
| Sodium Carbonate Peroxide | 4.0% |
| Water | ad 100% |
| TAED | 5.0% |
| PEG-90 | 4.5% |
| Alcohols, C₁₂₋₁₈, 7 EO | 19.5% |
| Sodium Silicate | 12.5% |
| PEG-4 | 0.5% |
| Diethylenetriamine penta (methylene phosphonate) | 7.0% |
| Zinc Sulfate | 1.1% |
| Subtilisin ® | 0.05% |
| Benzotriazole | 0.05% |
| Copolymer A (select one of Copolymers 1-5) | 1.5% |
| Mn-Complex | 0.05% |
| Perfume | q.s. |
| Direct Blue 86 | q.s. |
| Alpha-Amylase | 0.05% |
| Acid Yellow 36 | q.s. |
| Benzisothiazolinone | 0.05% |

### EXAMPLE C

| | |
|---|---|
| Pentasodium Triphosphate | 21.0% |
| Sodium Carbonate | 7.5% |
| Sodium Perborate | 4.5% |
| Water | ad 100% |
| Alcohols, C₁₁, 8 EO, 2 PO | 9.0% |
| TAED | 6.0% |
| Alcohols, C₈₋₁₀, 22 EO | 9.1% |
| Sodium Silicate | 10.5% |
| Disodium etidronate | 6.0% |
| Protease | 0.05% |
| PEG-80 | 12.0% |
| Amylase | 0.05% |
| PEG-8 | 6.0% |
| Copolymer A (select one of Copolymers 1-5) | 1.0% |
| Perfume | q.s. |
| Dye | q.s. |

### EXAMPLE D

| | |
|---|---|
| Pentasodium Triphosphate | 26.0% |
| Sodium Carbonate | 6.5% |
| Sodium Perborate | 4.5% |
| Water | ad 100% |
| Disodium Disilicate | 4.2% |
| Alcohols, C₁₂₋₁₆, 2 EO, 5 PO | 19.5% |
| PEG-80 | 12.0% |
| Sodium Silicate | 2.5% |
| Glycosidase | 0.05% |
| Sodium Sulfate | 3.0% |
| Protease | 0.05% |
| Mineral Oil | 4.5% |
| Disodium etidronate | 3.5% |
| Benzotriazole | 0.5% |
| Perfume | q.s. |
| Copolymer A (select one of Copolymers 1-5) | 3.0% |
| Colorant | q.s. |
| Limonene | q.s. |

### EXAMPLE E

| | |
|---|---|
| Pentasodium Triphosphate | 23.0% |
| Sodium Carbonate | 6.5% |
| Sodium Carbonate Peroxide | 4.5% |
| Alcohols, C₁₃₋₁₅, 2EO, 5PO | 19.1% |
| Sodium Sulfate | 2.5% |
| Copolymer A (select one of Copolymers 1-5) | 0.5% |
| Trideceth-7 | 2.0% |
| Dipropylene Glycol | 6.0% |
| TAED | 5.5% |
| Water | ad 100% |
| Sodium Silicate | 1.5% |
| Protease | 0.05% |
| Gglycosidase | 0.05% |
| Glycerin | 1.0% |
| Lauramine Oxide | 3.0% |
| C₉₋₁₁ Pareth-N (N = 3 to 8) | 3.0% |
| PEG-4 | 9.5% |
| Perfume | q.s. |
| Silica Dimethicone Silylate | 1.5% |
| Benzotriazole | 0.5% |
| Magnesium Carbonate | 1.0% |
| PEG-80 | 2.0% |
| (Acetato)Pentaaminecobalt Dinitrate | 0.05% |
| Colorant | q.s. |
| Geraniol | q.s. |
| Limonene | q.s. |

### PREPARATION OF EXAMPLES A TO E

All the ingredients are mixed together in a mixer. The resulting mixtures are tabletted in conventional tablet presses under a pressure of 750·10⁵ Pa.

Each of the formulations according to Examples A to E have been prepared with each of the Copolymers 1 to 5.

### CHEMICAL NAMES OF INGREDIENTS OF EXAMPLES A TO E

| | |
|---|---|
| C₉₋₁₁ | Alcohols, C₉₋₁₁, ethoxylated |
| Pareth-N | (8 mol EO average molar ratio) |
| Copolymer 1 | Sodium Acryloyldimethyltaurate/VP Copolymer; |
| | commercially available from Clariant under the trade |
| | name Hostagel ® AVS |
| Copolymer 2 | Copolymer of acryloyldimethyltaurate (83.3 wt.-%) and |
| | Genapol ® T-250 methacrylate (16.7 wt.-%); ammonium |
| | salt; non-crosslinked; prepared according to |
| | EP 1 069 142 |
| Copolymer 3 | Copolymer of acryloyldimethyltaurate (75.0 wt.-%) and |
| | Genapol ® UD-80 methacrylate (25.0 wt.-%); ammonium |
| | salt; non-crosslinked; prepared according to |
| | EP 1 069 142 |
| Copolymer 4 | Copolymer of acryloyldimethyltaurate (74.1 wt.-%) and |
| | Genapol ® T-250 methacrylate (24.7 wt.-%); ammonium |
| | salt; crosslinked (1.2 wt.-% methylenebisacrylamide); |
| | prepared according to EP 1 069 142 |
| Copolymer 5 | Acryloyldimethyltaurate Copolymer with alkylamin as |
| | counter ion; WO 2009/083130, Example 22 |
| Disodium | bisphosphonate |
| etidronate | |
| Genapol ® | (C₁₆-C₁₈) fatty alcohol polglycol ether with 25 EO |
| T-250 | (ethylene oxide) units |
| Genapol ® | C₁₁ oxo alcohol polglycol ether with 8 EO (ethylene |
| UD-80 | oxide) units |
| Mn-complex | [Mn(IV)₂ (μ-O)₃ (1,4,7-trimethyl-1,4,7-triazacyclononane)₂] |
| | 2 PF₆ |
| PEG-4 | Polyethylenglycol, 4 EO |
| PEG-8 | Polyethylenglycol, 8 EO |
| PEG-80 | Polyethylenglycol, 80 EO |
| PEG-90 | Polyethylenglycol, 90 EO |
| Sokalan ® | polycarboxylic acid |
| CP5 | |
| Subtilisin ® | Serin-Protease |
| TAED | tetraacetyl ethylenediamine |

1. A discrete or single dose detergent formulation comprising one or more copolymers A which comprise
a1) of from 1 to 50% by weight of one or more of the repeating structural units of the formula (1) 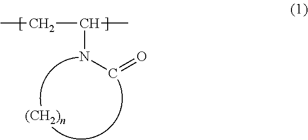
where
n is an integer of from 2 to 9
or
a2) of from 1 to 50% by weight of one or more of the repeating structural units of the formula (2) 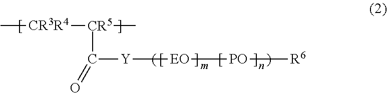
where
R³, R⁴ and R⁵ are, independently of one another, hydrogen or methyl,
R⁶ is hydrogen or an n-aliphatic, isoaliphatic, olefinic, cycloaliphatic, arylaliphatic or aromatic (C₁-C₃₀)-hydrocarbon radical,
Y is O or NH and
m and n are the stoichiometric coefficients relating to the ethylene oxide units (EO) and propylene oxide units (PO) and are, independently of one another, of from 0 to 50, where the sum of m and n must on average be 1 and the distribution of the EO and PO units over the -[EO]ₘ—[PO]ₙ— chain may be random, block-like, alternating or gradient-like,
and
b) of from 49.99 to 98.99% by weight of one or more of the repeating structural units of the formula (3) 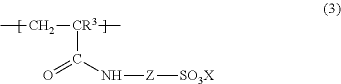
where
R³ is hydrogen or methyl,
Z is (C₁-C₈)-alkylene and
X is selected from the group consisting of H⁺, Li⁺, Na⁺, K⁺, Mg⁺⁺/2, Ca⁺⁺/2, Al⁺⁺⁺/3, NH₄⁺, monoalkylammonium, dialkylammonium, trialkylammonium and tetraalkylammonium, where the alkyl groups in these ammonium ions comprise, independently of one another, of from 1 to 30 carbon atoms.

2. A discrete or single dose detergent formulation according to claim 1, characterized in that the one or more copolymers A comprise of from 0.01 to 8% by weight of one or more crosslinking structures originating from one or more monomers having at least two olefinic double bonds.

3. A discrete or single dose detergent formulation according to claim 1 or 2, characterized in that the copolymers A possess a molecular weight M_{w} of from 10³ to 10⁹ g/mol.

4. A discrete or single dose detergent formulation according to one or more of claims 1 to 3, characterized in that the one or more structural units of the formula (1) originate from substances selected from the group consisting of N-vinylpyrrolidone (NVP) and N-vinylcaprolactam.

5. A discrete or single dose detergent formulation according to one or more of claims 1 to 4, characterized in that in the one or more structural units of the formula (2) R³, R⁴ and R⁵ are, independently of one another, hydrogen or methyl, R⁶ is an n-aliphatic, isoaliphatic or olefinic (C₅-C₂₂)-hydrocarbon radical, Y is O or NH, n is 0 and m is 1 to 30.

6. A discrete or single dose detergent formulation according to one or more of claims 1 to 5, characterized in that in the one or more structural units of the formula (3) R³ is hydrogen or methyl, Z is C₄-alkylene and X is selected from the group consisting of H⁺, Na⁺ and NH₄.

7. A discrete or single dose detergent formulation according to one or more of claims 1 to 6, characterized in that it comprises the one or more copolymers A in an amount of from 0.1 to 10% by weight.

8. Process for the preparation of a discrete or single dose detergent formulation according to one or more of claims 1 to 7 comprising the step of mixing all the ingredients in a mixer and compressing or tabletting the resulting mixture.

9. A method for treating table ware or glasses in an automatic dishwashing machine comprising the step of dissolving a discrete or single dose detergent formulation according to one or more of claims 1 to 7 in water and contacting the surface of the table ware or glasses with this solution.

10. A method according to claim 9 characterized in that it comprises a cleaning and/or a rinsing step.
